(19) United States
(12) Patent Application Publication
(10) Pub. No.: US 2011/0085764 A1
(43) Pub. Date: Apr. 14, 2011

(54) MODULAR OPTICAL MULTIPLE PLUG-TYPE CONNECTOR

(76) Inventors: Daniel Greub, St. Gallen (CH); Denise Skok, Stachen (CH)

(21) Appl. No.: 12/995,724

(22) PCT Filed: Jun. 3, 2009
(86) PCT No.: PCT/EP2009/056773

§ 371 Date: Dec. 2, 2010

(30) Foreign Application Priority Data
Jun. 3, 2008 (CH) 00840/08

(51) Int. Cl. G02B 6/38; H01R 13/46

(52) U.S. Cl. 385/60; 385/56; 439/625

(57) ABSTRACT

The present disclosure (20) relates to a connector with a modular construction. In order to achieve the highest possible channel density, inserts (1, 14) are arranged to form a stack-like composite and then inserted into a housing (21). The inserts (1, 14) are operatively connected to one another via operative connection means (17, 18).

The present invention relates to the field of plug-type connectors for connecting optical and/or electrical conductors.

Various plug-type connectors which have a modular design are known from the prior art. Modular plug-type connectors have the advantage that different plug-type connectors can be constructed from the same parts.

Optical plug-type connectors are used for connecting optically conducting fibers, for example made from glass or plastic. In the connectors, these fibers are pressed against one another at the end along from their end faces, such that the information to be transmitted by means of electromagnetic radiation (light) is coupled from one conductor into the next conductor. For optimum transmission, said fibers need to be centered precisely and to be provided with end faces which have been ground flat. The ends of the optical fibers to be connected are generally fixed in ferrules which are mounted in elastically resilient fashion and, assisted by said ferrules, are pressed against one another at the end by means of spring force. In the case of plug-type connectors with a large number of optical channels, considerable forces can thus occur which need to be absorbed and transmitted by the connector housings. Likewise, connectors need to be designed in such a way that they guarantee a safe connection over a relatively long period of time and with sometimes severely fluctuating environmental influences. In order to be able to guarantee optimum connection with little attenuation, high precision is required in terms of the coaxial alignment and centering. Good results are generally achieved with ceramic sleeves which are well set and are slotted on the side and which are plugged onto the ferrules and act as centering means.

In contrast to optical connectors, electrical connectors are usually not based on end-side contacts, but on the electrical connection along an outer surface of one first connector to a second connector. Since electrical connectors generally do not require any contact-pressure force at the end, said connectors are less sophisticated and are neutral in terms of the force ratios with respect to the connector housings, since the forces cancel one another out.

Connectors with a modular design which cover both sectors with a high level of quality are not known.

In order to be able to transmit as much data as possible in a space-saving manner with one connector, connectors with more than one conductor are generally used. One advantage consists in constructing a plug-connector such that it enables a packing density of the individual connector channels which is as high as possible, such that as much information as possible can be transmitted per unit area.

DE102004013905 by ADC GmbH was published in 2006 and discloses a glass fiber plug-type connector comprising at least one pair of plug-type connectors and a coupling. Each plug-type connector has a ferrule. In each case two ferrules in a pair of plug-type connectors are guided and aligned with respect to one another releasably within a guide sleeve. The coupling has in each case one receptacle for a plug-type connector. In order to provide a compact, space-saving glass fiber plug-type connection comprising few components, the coupling merely comprises one component part.

U.S. Pat. No. 5,190,472 by W. L. Gore & Associates, Inc., was filed in 1992 and discloses a multiple coaxial connector which has the aim of a high channel density. Individual coaxial connectors are half-inserted into comb-like, semicircular cutouts (arranged opposite one another on two sides) of a so-called grouping module from the side. Since the cutouts only surround the connectors by half, the individual connectors are not held in the individual cutouts and fall out of said cutouts. It is only by virtue of a plurality of grouping modules being layered laterally one on top of the other that the individual connectors are clamped and are thereby held. Without this layering one on top of the other, grouping modules as such are not functional. The layered grouping modules equipped with the individual connectors are pressed rigidly into an external frame from the rear and thus joined to form a functional multiple coaxial connector. The principle described of a multiple coaxial connector in theory makes possible multiple connectors with a comparatively high number of connectors, but has significant disadvantages. Firstly, the fitting is extremely difficult. Secondly, the individual, very filigree connectors are held very rigidly, which has a negative effect when constructing connectors with a high number of channels owing to the resulting chains of tolerance. A further disadvantage consists in the large number of very small and different component parts which are complex in terms of manufacture and therefore make the corresponding multiple coaxial connectors very expensive. This concept is not suitable for purely optical connectors and/or electrical connectors. Furthermore, the transfer of axial forces is not provided.

WO0159499 (henceforth WO'499) by the same Applicant was published in 2001 and describes a purely optical plug-type connector for simultaneous connection of a plurality of fiberoptic cables. The optical connector comprises a plug, in which a number of ferrules which corresponds to the number of fiberoptic cables to be connected are mounted laterally next to one another in resilient fashion in the plug-in direction, wherein each of the fiberoptic cables to be connected ends with its optical fiber in an associated ferrule and is fixed there. The possibility of flexible use alongside simple fitting and disassembly are achieved by virtue of the fact that each of the ferrules is mounted in resilient fashion in a separate insert and that the inserts are arranged, snapped-in, next to one another within the at least one plug in a common housing. In order that subsequent disassembly is possible, the inserts need to be accessible radially. Means are provided in the plug which are used for adjusting the inner part by virtue of rotation about its longitudinal axis in different angular positions. The essence of the invention described in WO'499 is considered to be that, individual spring-mounted ferrules are provided for each of the fibers. These spring-mounted ferrules are fitted in separate inserts. In order to form a multiple plug-type connector, a plurality of these inserts are accommodated next to one another rigidly in a common housing. By virtue of the use of individual ferrules, the fitting of the fiber ends is facilitated and, at the same time, a high degree of centering accuracy of the fibers is achieved. Owing to the prefitted inserts, there is no longer any need for intermediate or partition walls between the laterally adjacent inserts in the housing. The inserts for the optical plug-type connectors each have a holder in the form of a rectangular frame which is elongated in the plug-in direction and surrounds an interior, with an opening for the ferrule being provided in the front side of said frame and a through-bore for passing through the fiberoptic cable being provided in the rear side of said frame. For spring-mounting of the ferrule in the interior of the holder, a spring element in the form of a helical spring is provided. In addition to the arrangement in a row, mention is also made of the fact that the inserts could also be arranged next to one another and one above the other in a type of honeycomb structure in order to fill out a circular housing of a plug-type connector in optimum fashion, for example.

The connector known from WO'499 has the disadvantage that, at a relatively high number, the respective density of individual connectors in a combined structure (plug-type connector) the precision required for optimum quality can be adversely affected. The individual inserts are additionally not designed for particularly high multi-row packing density. There is likewise the problem of dissipating the forces occurring in the case of a high channel density properly over the housing.

WO03076997, by the same Applicant, was published in 2003 and discloses a fiberoptic plug-type connector system, which has an adapter and individual optical plug-type connectors in which a respective optical fiber ends in a ferrule. In order to produce an optical connection, the plug-type connectors can each be plugged into the adapter from two opposite sides. The adaptor has a plurality of guide sleeves arranged parallel next to one another in an adapter housing, with the optical plug-type connectors being capable of being plugged into said guide sleeves with their ferrules from both sides. With such a plug-type connector system, an extremely simple and space-saving design is achieved by virtue of the fact that the adapter housing comprises a plurality of separate parts which can be connected to one another and between which the guide sleeves are held with a clearance.

An object of the invention consists in providing a connector with a modular design which enables a particularly high, multidimensional packing density.

A further object of the invention consists in providing a connector with a modular design which is suitable both for optical and for electrical connections, or a combination of both types of connections.

A further object of the invention consists in providing a connector which has a considerable tolerance to external mechanical and thermal influences.

This object is achieved by a connector according to the independent patent claims.

A connector according to the invention makes it possible to arrange inserts optimized for this purpose densely next to one another in a row, which inserts enable an arrangement next to one another in a row with a high degree of precision. For this purpose, the inserts are pushed into a housing provided for this purpose and surrounding said inserts or inserted into said housing from the side and fixed therein. In order that the inserts can be operatively connected to one another or stacked in any desired manner, the inserts have operative connection means, by means of which they exchange forces with one another at least in the axial direction (fiber direction, conductor direction) or support one another and therefore avoid a relative movement with respect to one another. A design without the use of an intermediate wall is thus made possible. However, the supporting arrangement is constructed in such a way that the connector can nevertheless be fitted in a simple manner. By virtue of the above-described measures, the individual inserts can be stacked with a high packing density and without any intermediate walls, in contrast to the prior art, in more than one direction. Depending on the application area, the operative connection means are configured or arranged such that they act in transmitting fashion in more than one spatial direction. Conventional inserts require that said inserts are supported in each case always at least on one side directly on an outer housing or a partition wall, with the result that they are not stacked in multi-row fashion.

The housing into which the inserts are pushed is an outer housing of a connector or an intermediate housing, which is in turn inserted into an outer housing of a connector. The housing is generally of rigid design. Depending on the application area, however, said housing can be designed to be elastic at least in one direction, with the result that the inserts are mounted in floating fashion therein and therefore have a certain degree of adjustability. The housing can be produced from plastic or metal.

In one embodiment, the invention envisages inserts for connecting electrical conductors, in addition to inserts for optical conductors. In addition, inserts can be provided which are used in combination or as such as guide and/or coordination means. This may be a pair of inserts, for example, wherein a first insert comprises a pin-like element protruding in the axial direction which engages in a corresponding opening in an opposing insert or connector and can thus bring about alignment of two connector parts. Intermediate elements are possible.

A first embodiment of an insert according to the invention for an optical conductor has a holding frame with two opposing end faces, with a front, first opening and a rear, second opening. The holding frame at its front end serves to hold a cylindrical ferrule, which is arranged so as to protrude through the first opening. The ferrule is mounted in the holding frame so as to spring back in the axial direction counter to the force of a spring and can be pressed into the holding frame up to a certain extent. The spring force is of the order of magnitude of 5 newtons (N) per channel. At the opposite end, a fixing for the optical cable is provided. In one embodiment, the fixing may be a sleeve-like crimping neck, preferably made from metal, which has a flange-shaped thickened portion at its front end. The outer diameter of the crimping neck substantially corresponds to the inner diameter of the second opening, with the result that this is suitable for accommodating the crimping neck. The crimping neck is inserted from the inside into the second opening. The flange-shaped thickened portion in this case prevents any falling-out from the holding frame.

The holding frames of inserts according to the invention are configured such that they can be stacked seamlessly with further holding frames in two spatial directions. They generally have at least one operative connection means which protrudes from a side face and engages in a corresponding mating means of an adjacent insert. In the case of a grid-like arrangement of the inserts, the operative connection means are used for transmitting forces during plugging-in and unplugging and for mutually supporting the inserts during the connection process if the optical conductors are pressed against one another by means of spring force. The operative connection means make it possible to arrange inserts in such a way that they do not need to have a direction connection with a surrounding housing, but are held and guided primarily by the adjacent inserts. The operative connection means can be attached so as to protrude at the rear end of the holding frame, with the result that the holding frames can be pushed into a housing provided for this purpose individually and successively. The adjacent insert has a corresponding cutout for receiving the above-mentioned operative connection means. As an alternative or in addition, the operative connection means can also be arranged centrally. The operative connection means may be groove/pin pairs or similar elements which can be produced easily. Other possibilities are pin-shaped elements, which engage in a corresponding opening.

One problem consists in that comparatively high forces occur in the axial direction in a connector of the abovementioned type which has been equipped with a large number of optical channels. In particular at high packing densities and with the small dimensions between the individual optical conductors associated therewith, considerable problems can occur. These include, for example, time-dependent material fatigue, deformations in geometry etc. At a lateral distance of around 2 mm, for example, between the individual optical conductors and an end-side contact-pressure force of typically 5 N, a force of around 1.25 N/mm² results per unit area. In the case of a connector with an area of 100 mm² (around 25 optical channels), a constantly acting force or 125 N, i.e. 12.5 kg, results, which force needs to be absorbed and transmitted by the very small dimensions of the housing parts.

A second variant relates to inserts for operatively connecting electrical conductors. The inserts are advantageously compatible in terms of geometry with the first inserts for connecting optical conductors and can therefore be assembled to form a plug-type connector.

Both in the first and in the second insert, holding frames can be provided which are suitable for receiving more than one conductor. In particular in the case of electrical conductors, it may prove to be advantageous if the electrical conductors (for example positive and negative) are accommodated in one housing.

A third variant of inserts may be suitable for operatively connecting coaxial electrical conductors.

In a fourth variant, the inserts can be configured such that they act as mechanical operative connection and coordination means.

The holding frames advantageously have a cross section which can be stacked in a flexible manner in more than one spatial direction and which is rectangular, square or hexagonal, for example.

In one embodiment, a connector has a plurality of inserts which are stacked in the form of a grid next to one another in two spatial directions and which have been inserted in a housing surrounding them and are operatively connected to one another via at least one operative connection means. The operative connection means prevents a relative shift of the inner inserts with respect to the outer inserts at least in one spatial direction. The inserts can have an elongate holding frame with a front and a rear end face and side faces. The cross section of the inserts is advantageously rectangular or hexagonal, with the result that said inserts can be stacked seamlessly in two spatial directions. The operative connection means advantageously comprise an element which protrudes from a side face of an insert and a cutout which is formed so as to correspond to said element and is arranged on the opposite side of the insert. If required, more than one side face of an insert can be equipped with a laterally protruding element and/or a correspondingly configured depression with the result that the inserts can be operatively connected in more than one spatial direction. If required, the connector can have inserts for operatively connecting optical and/or electrical conductors. In one embodiment, an optical insert has an elongate holding frame with a front and a rear end side and side faces, wherein the front end side has an opening for receiving a ferrule and the rear end side has an opening for passing through an optical fiber. If required, the ferrule can be arranged in a flexible manner, with the result that it is mounted in such a way that it can spring back in the axial direction counter to the force of a spring arranged in an interior of the insert. The rear opening can be configured so as to receive a crimping neck which is inserted from the interior. The holding frame can comprise a plurality of parts which, when assembled, surround the interior. The inserts can be configured in such way that they are suitable for transmitting more than one data channel arranged parallel.

The invention will be explained in more detail below with reference to figures, which illustrate only exemplary embodiments and in which:

FIG. 1 shows a first embodiment of an insert in a side view from the left;

FIG. 2 shows the insert shown in FIG. 1 in a side view from the right;

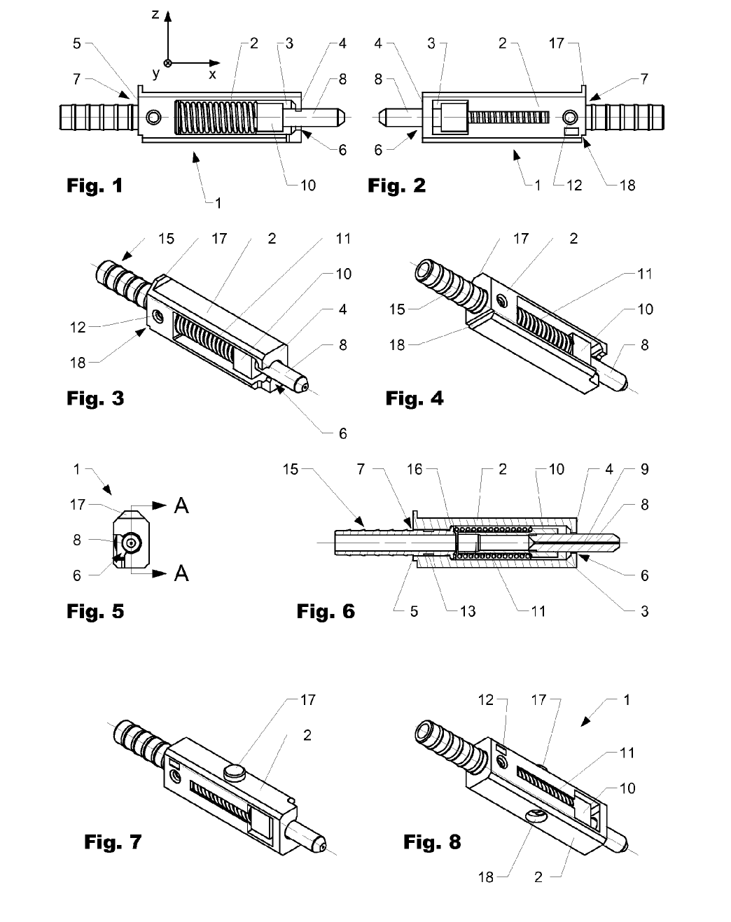

FIG. 3 shows the insert shown in FIG. 1 at an angle from above and the front;

FIG. 4 shows the insert shown in FIG. 1 at an angle from below and the rear;

FIG. 5 shows the insert shown in FIG. 1 from the front;

FIG. 6 shows a sectional illustration along the section line AA shown in FIG. 5;

FIG. 7 shows a second embodiment of an insert 1 at an angle from above and the front;

FIG. 8 shows the insert shown in FIG. 6 at an angle from below and the rear;

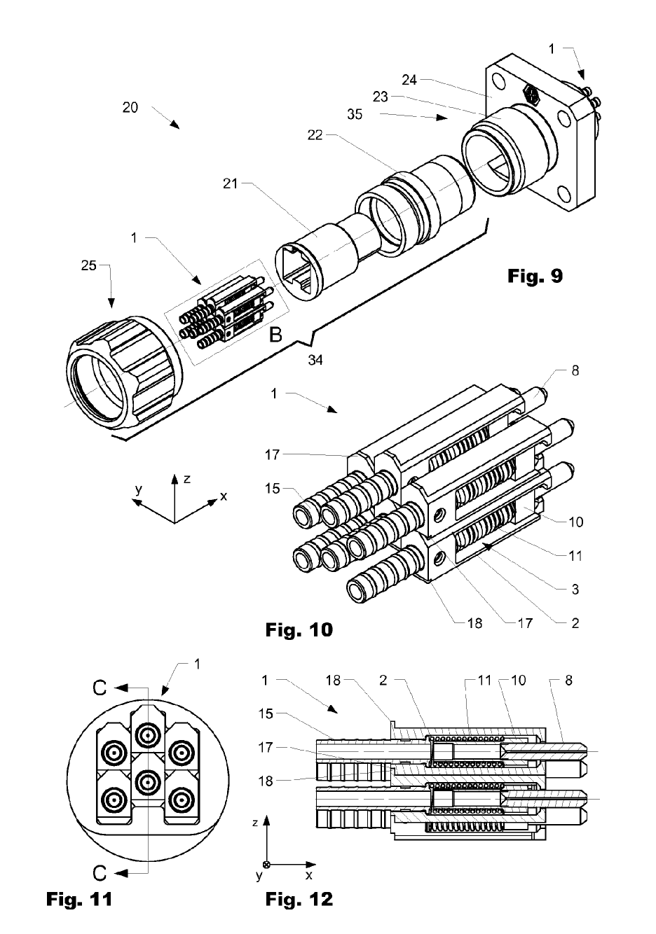

FIG. 9 shows, schematically, the design of a connector;

FIG. 10 shows detail B from FIG. 9;

FIG. 11 shows a stack of inserts as shown in FIG. 9 in a front view;

FIG. 12 shows a sectional illustration through the inserts shown in FIG. 11;

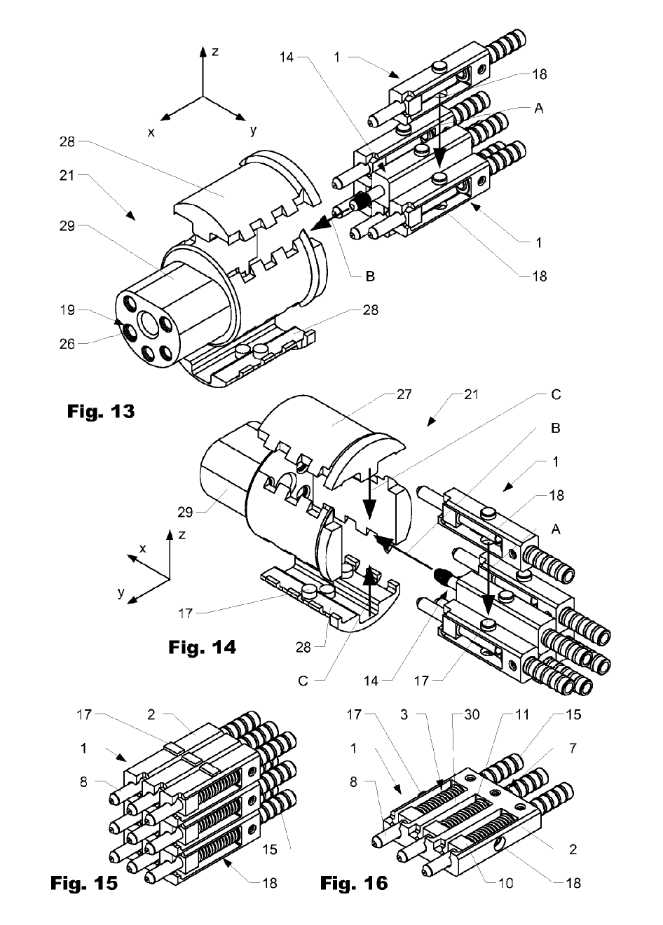

FIG. 13 shows a further embodiment of a connector at an angle from the front;

FIG. 14 shows the connector shown in FIG. 13 at an angle from the rear;

FIG. 15 shows a third embodiment of inserts;

FIG. 16 shows a fourth embodiment of inserts with a plurality of channels.

FIG. 1 shows a first embodiment of an insert 1 for an optical connector (cf. FIG. 9 for example) in a side view from the left. FIG. 2 shows the insert in a side view from the right. FIGS. 3 and 4 show the insert 1 in a perspective view at an angle from above and from the front and at an angle from below and the rear. FIG. 5 shows the insert 1 from the front and FIG. 6 shows a section through the insert shown in FIG. 5 along the section line AA. Mutually corresponding elements are generally provided with identical reference symbols in the subsequent figures.

FIG. 7 shows a second embodiment of an insert 1 in a perspective illustration at an angle from the front and above. FIG. 8 shows the insert 1 shown in FIG. 7 in a perspective illustration at an angle from below and the rear. The inserts shown in FIGS. 1 to 6 and 7 to are identical in terms of basic principle and are therefore described jointly. Any differences will be mentioned.

The inserts 1 are suitable for use with an optical conductor (not illustrated in any more detail) and a connector, as shown schematically in FIG. 9.

In the embodiments shown, the inserts 1 each have a substantially rectangular holding frame 2, which surrounds a cavity 3 which is accessible from both sides. Depending on requirements, the holding frames can also have another, for example multi-part design, wherein the individual parts are operatively connected to one another by virtue of, for example, a snap-type connection or by adhesive bonding or welding. The holding frames can also be formed with closed side faces.

At the front and rear end sides 4, 5, the holding frame 2 have, respectively, a front and a rear opening 6, 7. A ferrule 8 protrudes beyond the holding frame 1 through the front opening 6. In the fitted state, an optical conductor (not illustrated in any more detail) is adhesively bonded fixedly in the coaxial opening 9 in the ferrule 8. Said optical conductor is supported and guided by the ferrule 8 surrounding said conductor. The ferrule 8 opens out at its rear end into a guide element 10, wherein regions of said guide element 10 are square and said guide element is arranged in the interior of the cavity 3. The in this case rectangular cross section of the guide element 10 prevents any undesired rotation of the ferrule 8 with respect to the holding frame 2 about the longitudinal axis (x axis).

The ferrule 8 is mounted in elastically resilient fashion with respect to the force of a spring 11 arranged behind the guide element 10. As a result, the ferrule 8 and, with it, the optical conductor are pressed into the holding frame 2 counter to the force of the spring 11 in the axial direction. In the embodiments shown, the holding frame 2 is preferably produced from plastic. Depending on the application area, it is possible for the holding frame to be manufactured from metal, for example, by means of casting in the form of a stamped and bent part.

A sleeve-shaped crimping neck 15, which has a flange-like thickened portion 16 at the front end (cf. FIG. 6), is arranged in the rear opening 7. The crimping neck 15 is inserted into the rear opening 7 from the interior 3. The flange-like thickened portion 16 prevents the crimping neck 15 from falling out of the holding frame. Depending on the application area, there are other fixing possibilities, for example by virtue of the crimping neck being configured in the form of a press-in part which is pressed or snapped into the rear opening 7 laterally or from behind. For this purpose, the opening 7 can possibly be configured so as to be slotted on the side. In the embodiment shown, the holding frame 2 has, laterally in the region of the crimping neck 15, an opening 12 for introducing adhesive into a groove 13 (cf. FIG. 6) between the crimping neck 15 and the holding frame 2. As a result, the crimping neck 15 can be fixed easily with respect to the holding frame 2. Other fixing means are possible.

In the embodiments shown, the spring 11 is clamped in between the crimping neck 15 and the guide element 10 and has the effect that, firstly, the guide element 10 is pushed towards the front and, at the same time, the crimping neck is pushed towards the rear. In order that the spring 11 remains centered, the guide element 10 has a sleeve-shaped extended portion which protrudes into the spring 11 at the rear end.

In the embodiments shown, the front opening 6 is configured so as to be slotted, with the result that the ferrule 8 and the guide element 10 can be latched in from the side once the crimping neck 15 has been inserted into the rear opening 7 from the inside. Depending on requirements, the holding frames 2 can also be configured so as to receive more than one optical conductor laterally next to one another.

The inserts 1 are configured in such a way that, as illustrated in FIGS. 10 and 11, they can be stacked seamlessly in more than one spatial direction. The inserts 1 have operative connection means in the form of protruding elements 17 and depressions 18 with a design which corresponds to said elements. In the stacked position, the protruding elements 17 engage in the depressions 18 at least in one spatial direction and prevent undesired shifting of the inserts 1 relative to one another. Further explanations in this regard follow in connection with the subsequent figures.

The insert shown in FIGS. 1 to 5 has, at the rear end, a protruding, ridge-like element 17 which protrudes beyond a side face of the holding frame 2. On the opposite side, the holding frame has a correspondingly designed cutout 18. When the inserts 1 are stacked, the protruding element 17 engages in a cutout 18 of an adjacently arranged insert 1. In the embodiment shown in FIGS. 6 and 7, the operative connection means in the form of a protruding pin 17 and a correspondingly configured recess 18 are provided which engage in one another in the stacked state of inserts 1 and therefore prevent undesired shifting in the axial direction.

FIG. 9 shows, schematically, the design of a modular connector 20 in a perspective illustration at an angle from the front and above. The figure shows a plug-side connector part 34 and a jack-side connector part 35.

The plug-side connector part 34 is shown in the disassembled state (along the x-axis). In the stacked state, a plurality of inserts 1 are combined laterally next to one another and one above the other to form a stack. FIG. 10 shows the inserts 1 in an enlarged illustration (detail A from FIG. 9) at an angle from above in a grid-like combined structure stacked in a plurality of spatial directions. In the embodiment shown, the inserts 1 are arranged next to one another in a row directly in a space-saving manner and can thus be pushed into a first housing 21, in this case in the axial direction from the rear. The first housing 21 is used for holding the inserts 1. A second inner housing 22 surrounds at least regions of the first housing 21 and forms the transition to a third, outer housing 23 of the opposite jack-side connector part 35, which has a fixing flange 24. In the embodiment shown, the connector 20 is operatively connected to the jack-side connector part 35 by means of a union nut 25. Depending on the application area, the housings can have a different configuration.

The inserts 1 are fixed with respect to the first housing 21 in the axial direction by the operative connection means 17, 18. Since, when the inserts are arranged centrally, no direct holding is possible in the axial direction, at least at the rear end of said inserts where cables (not illustrated in any more detail) emerge from the crimping necks 15, this task is performed by the operative connection means 17, 18, with the result that a comparatively high cannel density in comparison with the prior art is possible.

In contrast to the housing-side connector part 20 shown, a compatible cable-side connector part (not illustrated in any more detail) does not normally have a flange. In the interior of the cable-side connector part, a number of inserts which corresponds to the number of housing-side inserts 1 is generally arranged coaxially with respect thereto. The cable-side inserts have likewise been inserted in a housing surrounding them and are held by said housing at least in the lateral direction. In the axial direction, at least the outer inserts are held by the operative connection means and/or the housing. The housing may be an intermediate housing or directly an outer housing of the connector part, which terminates the connector with respect to the outside. Depending on the configuration, the inserts are inserted into the housing surrounding them jointly or individually from the rear and/or from the side and are fixed there.

The first housing 21 likewise has at least one form of operative connection means which, in the fitted state, are in engagement with the operative connection means 17, 18 of the inserts 1. In the fitted state, the operative connection means 17, 18 are located one below the other and are in engagement with the first housing 1 and thus support the inserts 1 with respect to one another. The mutual support prevents inserts 1 which are not in direct contact with the first housing 21 from not being able to be shifted laterally as well. By virtue of the indirect support of the individual inserts 1 via the operative connection means 17, 18, the connector and its constituent parts can be constructed so as to be very small and therefore space-saving. Likewise, there is the possibility of providing other inserts (not illustrated in any more detail) which are compatible with the optical inserts shown and which are suitable, for example, for transmitting electrical signals or energy.

In one embodiment, the inserts can only be stacked in one spatial direction and are provided such that they are arranged laterally next to one another in a connector. Depending on the application area, the inserts of the described type are coupled to one another in one or two directions via operative connection means.

If required, the first housing 21 has a holder for centering means for mutually centering the ferrules to be connected (not illustrated in any more detail). As mentioned, good results are generally achieved with ceramic sleeves which are slotted on the side and which are plugged onto the ferrules with a snug fit. Depending on the configuration, the centering means can be pushed into the holder in the axial direction. In the case of the multi-row, grid-like arrangement of inserts shown in two spatial directions, the centering means are preferably inserted into a holder in the axial direction (x-axis) from behind and/or from the front. Depending on the configuration, the centering means are held by a cover or fixed by snap-type connections (neither of which is shown in detail).

Depending on the application area, the first housing 21 can be configured so as to be undeformable, with the result that the inserts are held rigidly in fixed fashion. If required, the housing 21 can be configured or arranged movably at least in one direction, with the result that the inserts are mounted in floating fashion to a certain degree.

FIG. 10 shows a grid-like arrangement of inserts 1 with three vertical rows arranged next to one another in the y direction. The inserts 1 in the central row are offset vertically upwards with respect to the outer two rows, as seen by the viewer. The inserts are coupled via the operative connection means arranged in this case at the rear end and in the z direction, for the viewer, with the result that an undesired relative shift in the x direction is avoided. FIG. 11 shows the stack of inserts 1 in a rear view and FIG. 12 shows a sectional illustration through the stack of inserts 1 along the section line CC from FIG. 11. FIG. 11 clearly shows how inserts are arranged next to one another seamlessly in a row in order to achieve maximum channel density. In this case, the operative connection means 17, 18 of the inserts 1 arranged one above the other are in engagement with one another and therefore prevent the inserts from being shifted with respect to one another in an undesired manner.

FIGS. 12 and 13 show, schematically, an embodiment of the inner workings of a connector in an exploded illustration. Inserts 1, 14 are illustrated in a combined structure in the form of a stack with three rows arranged next to one another in the y direction prior to their insertion into an in this case multi-part housing 21 in the axial direction (x direction). The fitting is illustrated schematically by arrows A, B and C. First, the inserts 1, 14 are combined to form the desired combined structure (arrow A). Then, the combined structure is inserted into the housing 21 (arrow B) with the result that the ferrules 8 of the inserts 1 are pushed into in this case sleeve-shaped centering means 26 which are located in openings 19 in the first housing 21. The housing of the compatible connector part generally does not have any openings 19 or any centering means 26. Then, a cover 27 and a base are brought into engagement with the operative connection mean 17, 18 protruding from the side faces of the inserts 1, 14 and with the housing central part 29, with the result that the inserts are fixed with respect to the housing 21.

In the embodiment shown, the combined structure of inserts shown comprises two different types. While first inserts 1 are optical in nature, second inserts 14 are designed for the transmission of electrical signals. Mixed forms are possible.

FIG. 15 shows a further embodiment of inserts 1 in a perspective illustration. The inserts 1 are arranged in the form of a block in a combined structure comprising 3×3 inserts 1. The protruding first operative connection means 17 are in the form of ridges and run approximately centrally and transversely over the holding frame 2. They engage in correspondingly configured recesses 18, which are formed on the opposite side.

FIG. 16 shows a further embodiment of an insert 1 in a perspective illustration at an angle from above. The insert shown has a holding frame 2 with a multi-cell design and is suitable for simultaneously receiving more than one data channel. This is shown by virtue of the fact that a plurality of ferrules 8 are mounted next to one another elastically so as to spring back counter to the force of the springs 11. The individual ferrules 8 are separated from one another by partition walls 30. Depending on the application area, the partition walls can be omitted, which makes it possible to increase the channel density. As can be seen, two opposite side faces have operative connection means 17, 18, which make it possible to functionally connect the inserts 1 to compatible single-cell or multi-cell inserts or to a housing. If required, as an alternative or in addition, the two other side faces can likewise be provided with operative connection means, with the result that an operative connection between a plurality of inserts in the other spatial direction is possible. In the embodiment shown, the crimping necks 15 are inserted into the rear opening 7 from the interior 3.

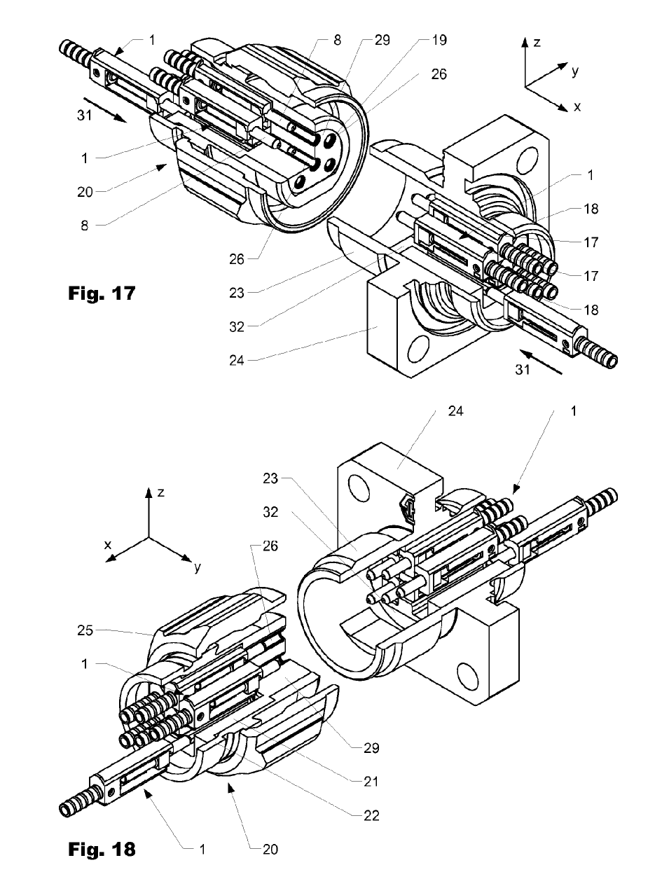

FIGS. 17 and 18 show the connector 20 shown in FIG. 9 in a partially sectional illustration, with the result that the inner design is shown more clearly.

Both in the plug-side and in the jack-side connector part 34, 35, the inserts 1 are stacked next to one another seamlessly and without any intermediate walls in two spatial directions (y, z), which results in a maximum channel density. If required, in certain embodiments at least certain regions can be divided by intermediate walls (not illustrated).

The inserts 1 are configured in such a way that they are pushed or snapped into the housings 21, 32 of the connector parts 34, 35 from the rear, as is indicated schematically by arrow 31. The inserts 1 are in the process held on both sides by means of the laterally protruding operative connection means 17, which engage in the cutouts 18 in the adjacent inserts or the intermediate housing 21, 32. A securing element (not illustrated in any more detail), which in this case is likewise attached from the rear (on the cable side) secures the inserts 1 with respect to the housings 21, 32 so as to thereby prevent undesired shifting thereof. If required, depending on the application area, the inserts can also be fixed in a different manner, for example by means of adhesive bonding, welding or by being snapped in. By virtue of the fact that the inserts are held by the operative connection means 17, 18, the housings 32 surrounding them can be configured so as to be open on the end side. This provides the advantage that the connectors can be constructed to be more compact and therefore shorter. In addition, the ferrules 8 can be guided over a longer distance. If required, ferrules are mounted in a sprung manner only on one connector side. The inserts are configured correspondingly. If required, the housings 21, 32 can at the same time form the outer housings of the connector 20.

In the embodiment shown, the plug-side intermediate housing 21 has a holder 29 (housing central part) for the centering means 26 of the ferrules 8 in the front region. In the embodiment shown, the centering means 26 are pushed into the openings 26 in the axial direction and are locked there advantageously in an interlocking manner so as to prevent undesired shifts. By virtue of the special configuration of the holder 29 for the centering means 26, it is possible to design a compact, multi-row connector 20. If required, the holder 29 can be configured as an element which is separate from the housings 21, 32, which element can be operatively connected to said housings, if required at least on one connector side, or else is inserted between the connector parts as a separate element. Such a separate centering means holder represents a further way of making the design of a connector more flexible. One advantage consists in that the holder can be configured in such a way that it is detached from the connector. In addition, the optical conductors and ferrules can be ground on both connector sides in the combined structure.

### LIST OF REFERENCE SYMBOLS

1 Insert (optical)
2 Holding frame
3 Cavity/inner region
4 Front side
5 Rear side
6 Front opening
7 Rear opening
8 Ferrule
9 Coaxial opening
10 Guide element
11 Spring
12 Opening for adhesive
13 Groove for adhesive
14 Insert (electrical)
15 Crimping neck
16 Thickened portion
17 Protruding element (operative connection means)
18 Cutout (operative connection means)
19 Openings for centering means
20 Connector
21 First housing
22 Second housing
23 Third housing
24 Fixing flange
25 Union nut
26 Centering means for ferrules
27 Cover
28 Base
29 Housing central part
30 Partition wall
31 Arrows (insertion of centering means)
32 Intermediate housing (1^{st} housing)
33 Rear cover
34 Plug-side connector part
35 Jack-side connector part

1. A connector comprises a plurality of inserts which are stacked next to one another in two spatial directions in the form of a grid and which have been inserted into a housing surrounding said inserts and are operatively connected to one another via at least one operative connection means, which, in a targeted manner, prevents a relative shift of inner inserts with respect to outer inserts at least in one spatial direction.

2. The connector as claimed in claim 1, wherein the inserts further comprise an elongate holding frame with a front and a rear end side and side faces.

3. The connector as claimed in claim 1, wherein the inserts have one of a rectangular and hexagonal cross section such that they are stackable seamlessly in two spatial directions.

4. The connector as claimed in claim 1, wherein the operative connection means comprises an element which protrudes from a side face of an insert and a cutout which is formed so as to correspond to said element and is arranged on the opposite side of the insert.

5. The connector as claimed in claim 4, wherein more than one side face of an insert is equipped with a laterally protruding element and/or a correspondingly configured depression, such that the inserts are operatively connected in more than one spatial direction.

6. The connector as claimed in claim 1, wherein the connector has inserts for operatively connecting optical and/or electrical conductors to one another.

7. The connector as claimed in claim 1, wherein the inserts for operatively connecting an optical conductor have an elongate holding frame with a front and a rear end side and side faces, the front end side having an opening for receiving a ferrule and the rear end side has an opening for passing through an optical fiber.

8. The connector as claimed in claim 7, wherein the ferrule is mounted such that it springs back in the axial direction counter to the force of a spring arranged in an interior of the insert.

9. The connector as claimed in claim 8, wherein the rear opening is used for receiving a crimping neck inserted from the interior.

10. The connector as claimed in claim 8, wherein the holding frame comprises a plurality of parts, which surround an interior.

11. The connector as claimed in claim 1, wherein an insert serves to convey more than one data channel arranged in parallel.

12. The connector as claimed in claim 1, wherein the inserts are arranged laterally offset with respect to one another.

13. The connector as claimed in claim 1, wherein the housings for receiving the inserts have operative connection means for coupling to the operative connection means of the inserts.

14. The connector as claimed in claim 1, wherein the housings for receiving the inserts have a holder for the centering means of the ferrules.

15. The connector as claimed in claim 1, wherein the housings for receiving the inserts are open at one end.

16. An insert for use in a connector as claimed in claim 1.
